(19) United States
(12) Patent Application Publication
(10) Pub. No.: US 2011/0141730 A1
(43) Pub. Date: Jun. 16, 2011

(54) Lamp of replaceable LED

(76) Inventor: Han-Ming Lee, Hsinchu City (TW)

(21) Appl. No.: 12/653,339

(22) Filed: Dec. 14, 2009

(51) Int. Cl. F21V 1/00; F21V 7/00

(52) U.S. Cl. 362/235; 362/296.01

(57) ABSTRACT

The present invention relates to a lamp of replaceable LED, comprising the lamp cover, translucent board, reflective frame, conducting plate, circuit board, LED lamp, lamp seat, copper head and a plurality of connecting screws, and in particular to one wherein the reflective frame is provided with equally spaced semicircle lamp cups, the lamp cups are provided with connected cross ring grooves for embedding and fastening of the convex plate above the conducting plate and embedding of the positive and negative conducting brackets of the LED lamp into the cross ring grooves in the lamp cups to form the weld-free rapid pressing device with the convex plate above the conducting plate so as to achieve the integrated stable conducting effect, prevent the quality of chips from being undermined due to traditional direct solder fusion and provide the convenience of replacing the LED lamp rapidly.

### BACKGROUND OF THE INVENTION

In recent years, the integrated weld power-saving LED lamp has emerged and replaced the traditional daylight lamp. The welded circuit board of the chip cup bracket needs to be fully fused with solder at high temperature so that the bracket and circuit board are welded firmly together; during the process of fusing with solder at high temperatures, the heat is transferred along the bracket to the chips above the bracket within a very short period of time, therefore significantly shortening the service life of the chips being heated directly. Hence, it is indeed necessary for the industry to innovate and perfect this bracket welding connection structure.

### SUMMARY OF THE INVENTION

The primary purpose of the present invention is to provide a lamp of replaceable LED and in particular one in which the lamp cups are provided with connected cross ring grooves for embedding and fastening of the convex plate above the conducting plate and embedding of the positive and negative conducting brackets of the LED lamp into the cross ring grooves in the lamp cups to form the weld-free rapid pressing device with the convex plate above the conducting plate so as to achieve the integrated stable conducting effect.

The secondary purpose of the present invention is to provide a lamp of replaceable LED and in particular to one in which the ring grooves are available for the circuit board and two conducting brackets to be pressed and fastened into the grooves in a staggered manner to prevent the efficiency of LED from being undermined due to traditional direct solder fusion and significantly extend the service life of the LED chips.

Another purpose of the present invention is to provide a lamp of replaceable LED, wherein the lamp cover, conducting plates and lamp seat are provided with a plurality of radiating holes for convective diffusion of the heat inside the lamp and decreasing the temperature, therefore achieving the objective of decreasing the accumulation of heat and reducing the optical decay of the known enclosed structure.

### BRIEF DESCRIPTION OF THE DRAWINGS

FIG. 1 is a 3D diagram of the present invention.

FIG. 2 is a schematic diagram of the components of the present invention.

FIG. 3 is a cross-section 3D diagram of the present invention.

FIG. 4 is a schematic of the circuit board and LED conducting brackets embedded and fastened into the ring groove of the present invention to stabilize the conducting function.

FIG. 5 is a schematic of the conducting brackets pressed into the ring grooves of the present invention.

FIG. 6 is a cross-section schematic of the lighting function of the chips of the present invention.

FIG. 7 is a 3D schematic of another embodiment of the present invention.

FIG. 8 is a decomposition schematic of the components of another embodiment of the present invention.

### DETAILED DESCRIPTION OF THE PREFERRED EMBODIMENT

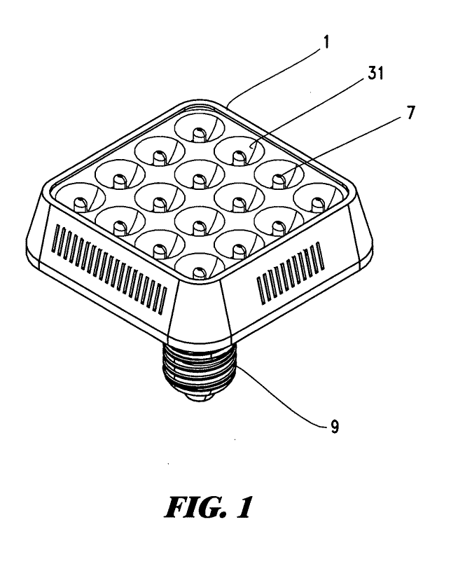

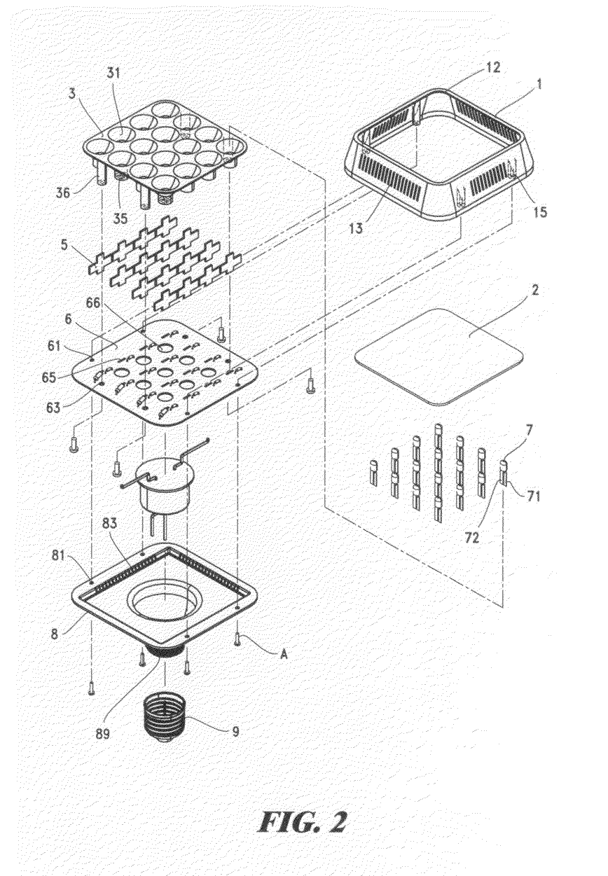

Please refer to FIG. 1 and FIG. 2. The present invention relates to a lamp of replaceable LED, comprising the lamp cover 1, translucent board 2, reflective frame 3, conducting plate 5, circuit board 6, LED lamp 7, lamp seat 8, copper head 9 and a plurality of connecting screws A; the lamp cover 1 is a square taper open thin cover, the opening is provided with snap ring groove 12, its ring walls are provided with equally spaced radiating holes 13, and the ring grooves are also provided with locking pole holes 15 inside its ring walls; the translucent board 2 is a thin board made of light-transmitting material for embedding into the snap ring groove 12 at the lamp cover opening; the reflective frame 3 is a square reflective frame opposite to the lamp cover opening and is provided with equally spaced concave semicircle lamp cups 31, the lamp cups are provided with connected convex cross ring grooves 35, and the outer ring at the bottom of the reflective frame is provided with a plurality of locking pole holes 36; the conducting plate 5 is a conducting plate connected with the cross thin plate for upward embedding of the convex plate at the top into the cross ring grooves 35 for fastening; the circuit board 6 is a trapezoidal conducting control circuit board in relative to the lower opening of the lamp cover, the locking pole holes 15 of the circuit board in relative to the bottom of the lamp cover are provided with a plurality of screw holes 61, and the locking pole holes 36 and cross ring grooves 35 of the circuit board in relative to the bottom of the reflective frame are provided with a plurality of screw holes 63, locating grooves 65 and radiating holes 66 for embedding of the convex plate at the bottom of the conducting plate into the locating groove 65 for fastening, threading of the screw A into the screw holes 63 and locking pole holes 36 for fastening; the LED lamp 7 is a translucent rubber injection sealing a plurality of chips, a plurality of conducting wires and the positive/negative conducting brackets 71 and 72, the positive/negative conducting brackets are provided for embedding into the cross ring grooves 35 in the lamp cups 31 to form the weld-free quick pressing device with the convex plate above the conducting plate 5 to offer the stable conducting effect; the lamp seat 8 is a trapezoidal ladder lamp seat in relative to the lower opening of the lamp cover, the ladder surface is provided with a plurality of screw holes 81 in relative to the locking pole holes 15 at the bottom of the lamp cover for threading of the screw A into the screw hole 81 for fastening with the lock pole hole 15 via the screw hole 61, its ladder ring diameter is provided with equally spaced radiating holes 83; moreover, a threaded connecting snap ring 89 projects downward from the center of the seat; the copper 9 is a traditional bulb screw conducting joint for fastening of the snap ring 89 below the lamp seat.

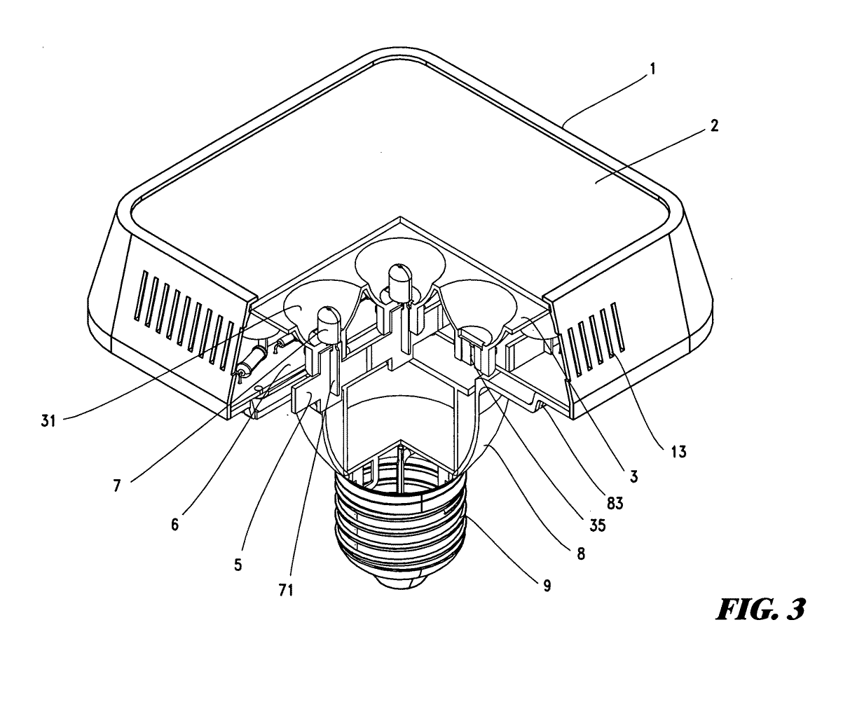

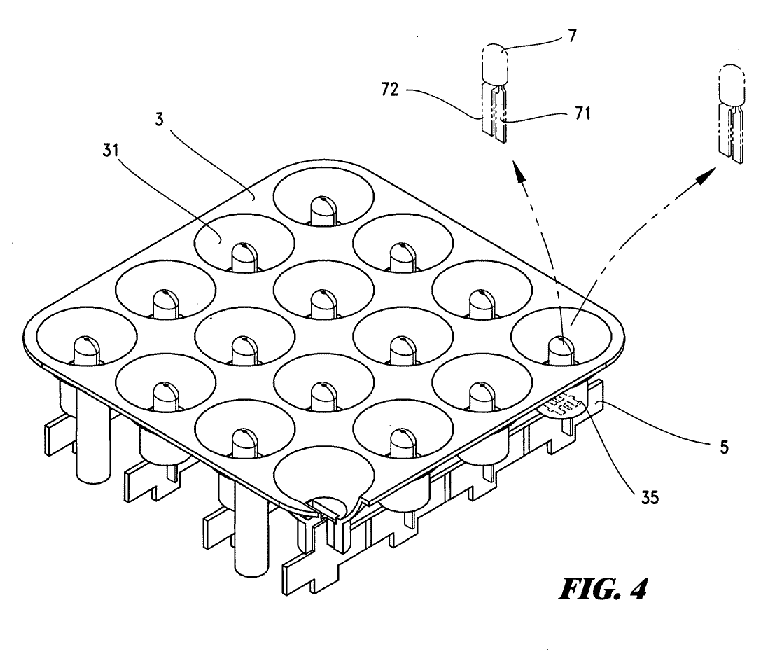

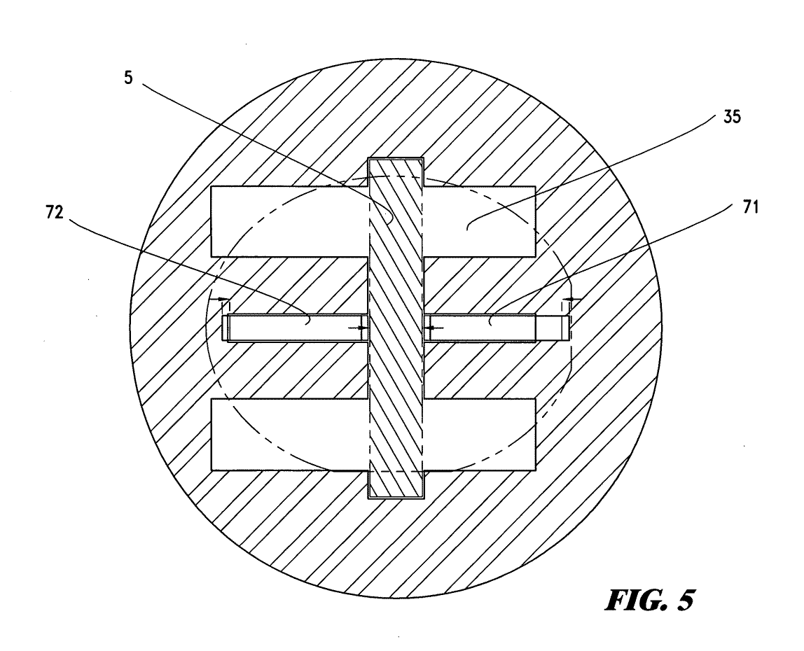

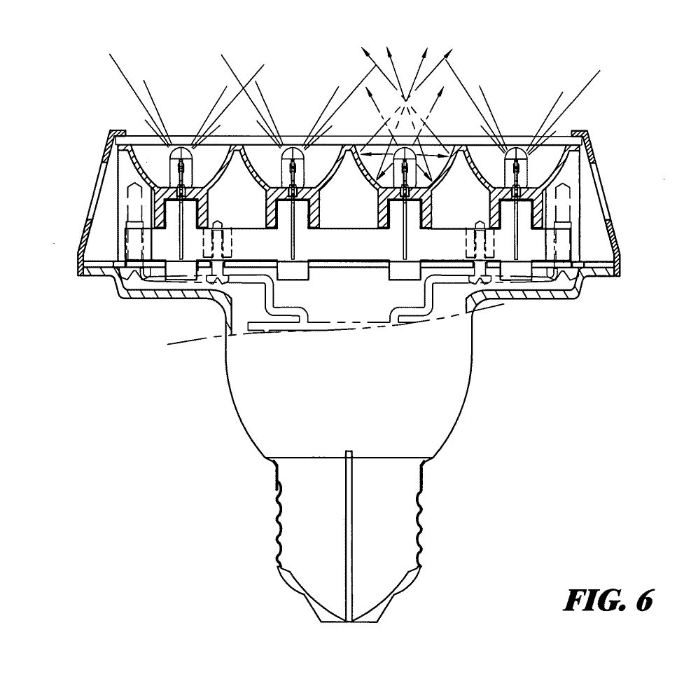

Please refer to FIG. 3 through FIG. 6 for the embodiment of the present invention. The reflective frame 3 is provided with equally spaced semicircle lamp cups 31, the lamp cups are provided with connected cross ring grooves 35 for embedding and fastening of the convex plate above the conducting plate 5, and embedding of the positive/negative conducting brackets 71 and 72 of the LED lamp 7 into the cross ring grooves 35 in the lamp cups so as to from the weld-free quick pressing device with the convex plate above the conducting plate 5 to achieve the stable conducting effect, prevent the quality of chips from being undermined due to traditional direct solder fusion and provide the convenience of replacing the LED lamp rapidly. Moreover, the lamps are provided with a plurality of radiating holes 13, 66 and 83 for convective diffusion of the heat inside the lamp and decreasing the temperature, therefore achieving the industrial application of decreasing the accumulation of heat and reducing the optical decay of the known enclosed structure.

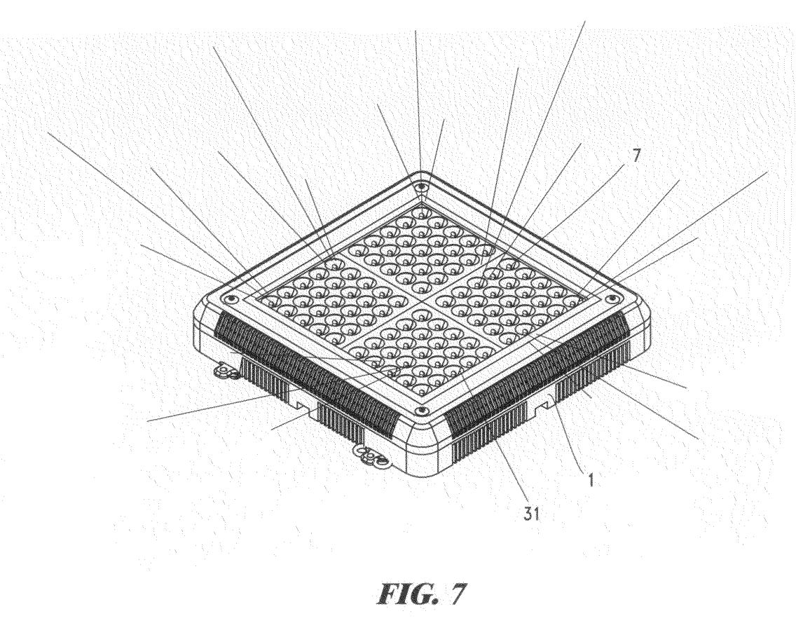

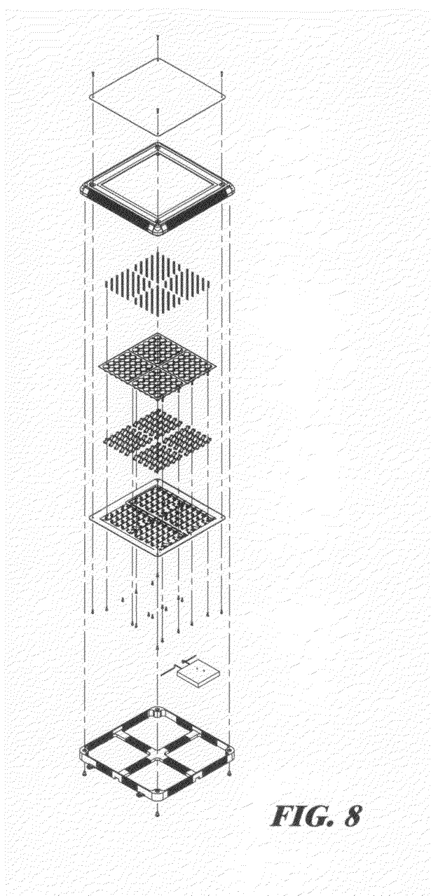

Please refer to FIG. 7 and FIG. 8 for another embodiment of the present invention. The above structure may be implemented to achieve simultaneous lighting of multiple LED lamps, replace the traditional daylight lamps and form the weld-free rapid pressing device to achieve the integrated stable conducting effect and further provide the convenience of replacing the LED lamp rapidly, which is totally different from existing integrated conducting plate welded lamp whereby the damaged LED may not be replaced with a new one.

I claim:

1. A lamp of replaceable LED, comprising the lamp cover, translucent board, reflective frame, conducting plate, circuit board, LED lamp, lamp seat, copper head and a plurality of connecting screws, wherein, the lamp cover is a square taper open thin cover, the opening is provided with snap ring groove, its ring walls are provided with equally spaced radiating holes, and the ring grooves are also provided with locking pole holes inside its ring walls; the translucent board is a thin board made of light-transmitting material for embedding into the snap ring groove at the lamp cover opening; the reflective frame is a square reflective frame opposite to the lamp cover opening and is provided with equally spaced concave semicircle lamp cups, the lamp cups are provided with connected convex cross ring grooves, and the outer ring at the bottom of the reflective frame is provided with a plurality of locking pole holes; the conducting plate is a conducting plate connected with the cross thin plate for upward embedding of the convex plate at the top into the cross ring grooves for fastening; the circuit board is a trapezoidal conducting control circuit board in relative to the lower opening of the lamp cover, the locking pole holes of the circuit board in relative to the bottom of the lamp cover are provided with a plurality of screw holes, and the locking pole holes and cross ring grooves of the circuit board in relative to the bottom of the reflective frame are provided with a plurality of screw holes, locating grooves and radiating holes for embedding of the convex plate at the bottom of the conducting plate into the locating groove for fastening, threading of the screw A into the screw holes and locking pole holes for fastening; the LED lamp is a translucent rubber injection sealing a plurality of chips, a plurality of conducting wires and the positive/negative conducting brackets, the positive/negative conducting brackets are provided for embedding into the cross ring grooves in the lamp cups to form the weld-free quick pressing device with the convex plate above the conducting plate to offer the stable conducting effect; the lamp seat is a trapezoidal ladder lamp seat in relative to the lower opening of the lamp cover, the ladder surface is provided with a plurality of screw holes in relative to the locking pole holes at the bottom of the lamp cover for threading of the screw A into the screw hole for fastening with the lock pole hole via the screw hole, its ladder ring diameter is provided with equally spaced radiating holes; moreover, a threaded connecting snap ring projects downward from the center of the seat; the copper is a traditional bulb screw conducting joint for fastening of the snap ring below the lamp seat; the reflective frame is provided with equally spaced semicircle lamp cups, the lamp cups are provided with connected cross ring grooves for embedding and fastening of the convex plate above the conducting plate, and embedding of the positive/negative conducting brackets of the LED lamp into the cross ring grooves in the lamp cups so as to from the weld-free quick pressing device with the convex plate above the conducting plate to achieve the stable conducting effect, prevent the quality of chips from being undermined due to traditional direct solder fusion and provide the convenience of replacing the LED lamp rapidly.

2. The lamp of replaceable LED according to claim 1, wherein the cross ring grooves in the lamp cup are provided for staggered embedding of a plurality of LED lamp brackets so that the variant combinations of more than one LED lamp can be achieved in the lamp cup.
